(19) United States
(12) Patent Application Publication
(10) Pub. No.: US 2014/0254991 A1
(43) Pub. Date: Sep. 11, 2014

(54) Isolator

(71) Applicant: Bernhard STRZALKOWSKI, Munich (DE)

(72) Inventor: Bernhard STRZALKOWSKI, Munich (DE)

(73) Assignee: Analog Devices Technology, Hamilton (BM)

(21) Appl. No.: 13/787,362

(22) Filed: Mar. 6, 2013

(51) Int. Cl. G02B 6/43

(52) U.S. Cl. CPC G02B 6/43
USPC 385/89

(57) ABSTRACT

An isolator comprising: a first semiconductor substrate including a first electrical circuit; a second semiconductor substrate including a second electrical circuit; and at least one optical waveguide for data exchange between the first and second electrical circuits.

### FIELD OF THE INVENTION

The present disclosure relates to an isolator for providing signal transmission between circuits or components at dissimilar voltages.

### BACKGROUND

There are instances where signals from, or to, relatively high voltage circuits such as power transmission systems, electric motors and the like need to be coupled to processing circuits which are typically run at a much lower voltage. Similarly there may be a need to send data from processing circuits which may derive their power from mains driven power supply units to safety critical systems, such as medical apparatus directly connected to a patient. In each of these circumstances there is a need to allow signals to propagate between one circuit and another whilst maintaining galvanic isolation between the circuits.

Discrete isolation circuits are known where, for example, one circuit is formed on a first printed circuit board, another circuit is formed on a second printed circuit board and the circuits exchange data by way of a transformer coupling the circuits together.

### SUMMARY

According to a first aspect of the present invention there is provided an isolator comprising a first semiconductor substrate including a first electrical circuit, a second semiconductor substrate including a second electrical circuit, and at least one optical waveguide for data exchange between the first and second electrical circuits.

It is thus possible to provide an isolator within a single chip (integrated circuit) package wherein data is exchanged between the first and second electrical circuits by way of optical interconnection. The use of a single chip package, i.e. a device that looks like an integrated circuit such as a dual in line package and its more modern successors, provides a small and robust isolator which is suitable for inclusion within electronic circuitry. The use of an optical data link within the isolator provides enhanced galvanic isolation. For example capacitive coupling between the first and second electrical circuits allows for the potential of voltage transients to be transmitted across the capacitor. Transformers theoretically do not suffer from this problem, however there can be parasitic capacitive coupling between primary and secondary winding of a transformer potentially giving rise to the same problem. The use of photonic coupling substantially alleviates either of these problems.

Optical transmitters and optical receivers are available with large bandwidths. Where, for example, the data to be transmitted between the first and second circuits is transmitted in a digital form existing electrical transmitters, such as mode locked lasers, can achieve transmission rates of several Gigabits per second. Receiver technology, for example based on Schottky barrier detectors, can receive data and demodulate it at these data rates.

According to a second aspect of the second invention there is provided a method of providing electrical isolation within a single integrated circuit package having a first circuit formed using very large scale integration technology on a first semiconductor substrate and a second circuit formed using very large scale integration technology on a second semiconductor substrate, wherein the first and second semiconductor substrates are provided on respective carriers within the integrated circuit package, the method providing exchanging data between the first and second circuits by way of optical signals conveyed in photonic waveguides.

### BRIEF DESCRIPTION OF THE DRAWINGS

Embodiments of the invention will now be described, by way of non-limiting example only, with reference to the accompanying Figures, in which:

FIG. 1 schematically illustrates an isolator providing signal transmission between high voltage inputs and outputs of a high voltage circuit and low voltage inputs and outputs of a low voltage circuit whilst maintaining galvanic isolation between the high voltage circuit and low voltage circuit according to an embodiment.

FIG. 2 is a plan view of an isolator having optical coupling between first and second circuits according to an embodiment.

FIG. 3 is a cross second through the arrangement shown in FIG. 2 along the line A-A′ according to an embodiment.

FIG. 4 is a plan view of first and second semiconductor substrates carried by respective lead frames according to an embodiment.

FIG. 5 is a cross section through a variation of the arrangement shown in FIGS. 2 and 3 where the first and second semiconductor substrates are carried on a shared carrier, such as a lead frame according to an embodiment.

FIG. 6 shows a variation to that shown in FIG. 5 according to an embodiment.

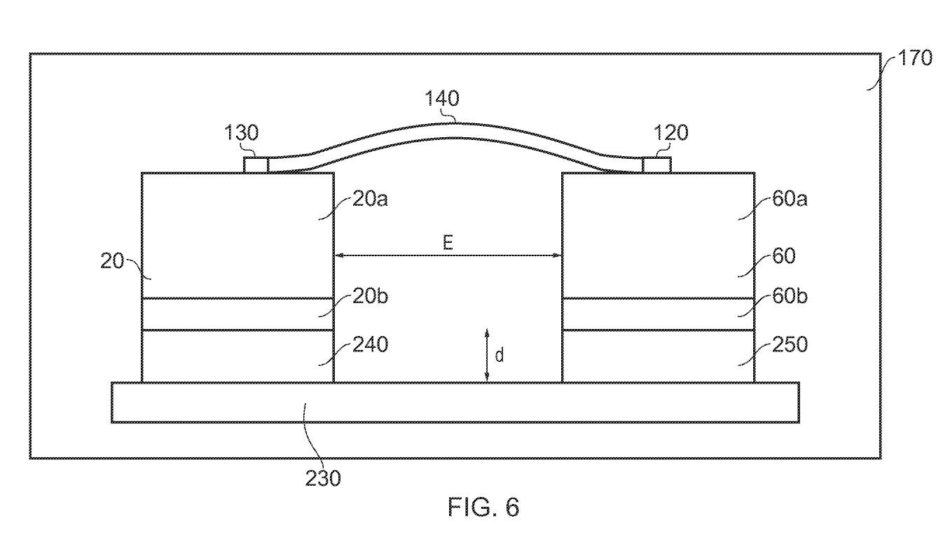

### DESCRIPTION OF SOME EXAMPLE EMBODIMENTS

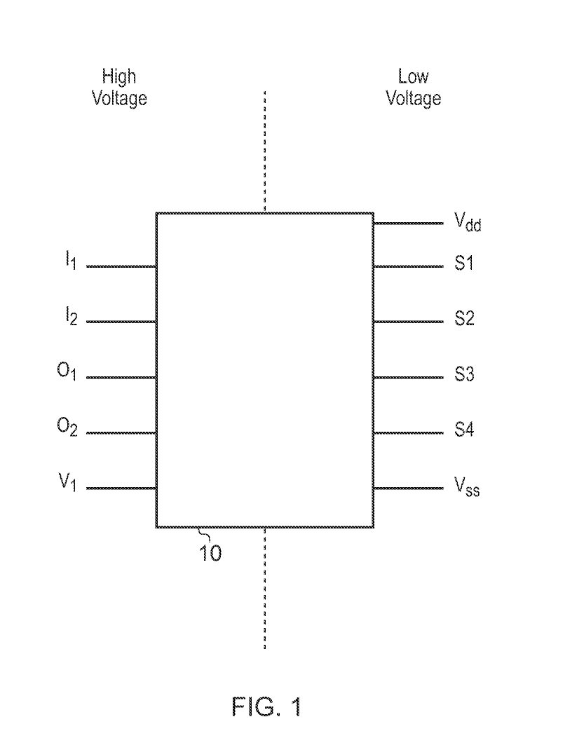

FIG. 1 schematically represents a voltage isolator 10 whose function, as known to the person skilled in the art, is to allow data to be transmitted between a “high voltage” circuit and a “low voltage” circuit. The low voltage side of the isolator 10 may be required to receive logic signals, and transmit logic signals, between a voltage range of V_{DD} and V_{SS} which may typically be around 0 and 5 volts measured with respect to a low voltage ground. The voltages V_{DD} and V_{SS} may be derived from a battery power source or alternatively may be derived from a voltage regulator powered, for example, from a local mains voltage supply.

The high voltage side may be connected to receive signals from, and provide control signals to, circuits at a much higher voltage, for example at mains voltage or higher. Thus the isolator may be expected to receive first and second input signals I₁ and I₂, and provide first and second output signals O₁ and O₂ at the high voltage side measured with respect to a high voltage reference V₁. The isolator 10 typically includes signal processing and/or signal transformation circuits in order to facilitate the signal transmission without burdening the circuits that it is connected to. The isolator may be required to withstand voltage differences of several thousand volts whilst providing isolation between the high voltage and low voltage circuits. Isolators of the type shown in FIG. 1 may also be used to provide isolation between first and second low voltage circuits where, for example, one of the circuits derive its power from its power regulator, and a fault on the regulator must not result in mains voltage being transmitted across the isolator. Such a situation arises in equipment such as medical monitoring equipment.

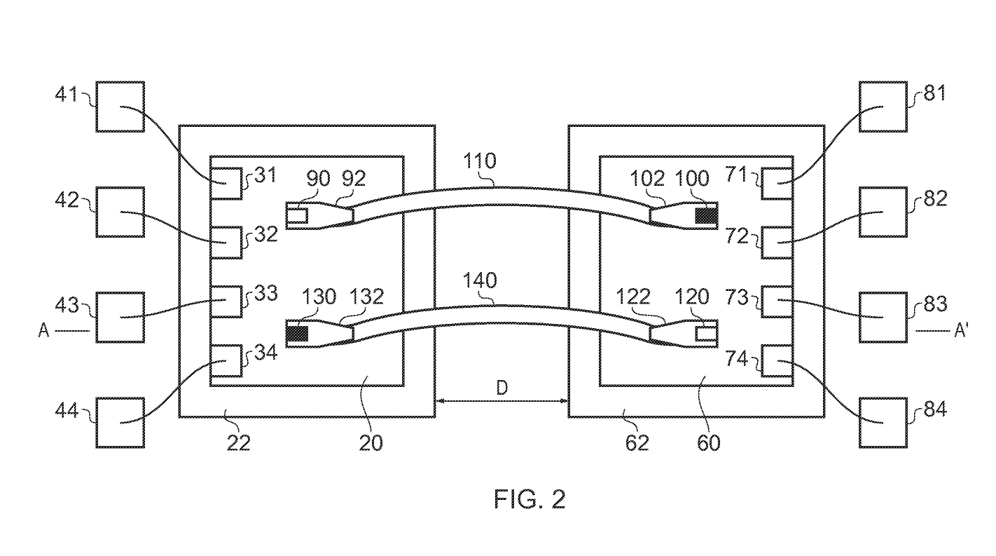

FIG. 2 schematically shows an isolator in which a first semiconductor die 20 has a first electrical circuit formed therein for providing data communication across an isolation barrier. The first semiconductor die is carried on a first carrier, such as a lead frame 22. The first semiconductor substrate includes bond pads 31 to 34 such that wire bonds may be formed between the bond pads 31 and 34 and corresponding connections 41 to 44 of the lead frame 22.

A second semiconductor substrate 60 carrying a second circuit is provided on a second carrier 62, such as a lead frame. The second semiconductor substrate includes metallic bond pads 71 to 74 such that wire interconnects may be formed between the bond pads 71 to 74 and corresponding connections 81 to 84 of the second lead frame 62. The first and second semiconductor substrates 20 and 60 are bonded to their lead frames 22 and 62 and encapsulated within a single integrated circuit package. In order to provide galvanic isolation, the lead frames 22 and 62 are separated from each other by a distance D. In broad terms, the larger the distance D then the larger the voltage difference between the first and second semiconductor substrates 20 and 60 can be supported before a breakdown path occurs within the chip package destroying the isolation between the first and second semiconductor substrates 20 and 60. Typically D is greater than 50 microns, and is often greater than 100 microns. In some embodiments is greater than 200 microns. Without being typically bound to this distance, the applicant is currently intending for the separation distance D to be around 400 microns.

Although the first and second semiconductor substrates 20 and 60, and the circuits formed thereon are now galvanically isolated, they still need to exchange data between the circuits whilst maintaining the isolation. In order to pass information from the first semiconductor substrate 20 to the second semiconductor substrate 60, a optical transmitter 90 is formed on the first semiconductor substrate 20 and an optical receiver 100 is formed on the second semiconductor substrate 60. The optical transmitter 90 may for convenience be associated with a waveguide 92 which may taper slightly so as to enhance a connection between the transmitter 90 and a flexible waveguide 110, such as a photonic wire. Similarly the receiver 100 may be provided within a tapered waveguide 102 so as to facilitate connection to the photonic wire 110. Any suitable transmitter and receiver technology may be used. However, where very high bit rates are required, for example several gigabits per second then it is expected that the transmitter 90 may comprise a nano-laser and associated modulator, so as to form a plasmatronic transmitter, whereas the receiver module may comprise a Schottky barrier detector. Parallel channels can be used to provide higher data rates.

Photonic wires offer smaller chip to chip contact areas than conventional connections. Photonic wires can be created by, for example, two-photon polymerization of negative tone resist materials in the focus of a high numerical aperture laser beam. Thus once the first and second semiconductor substrates 20 and 60 have been placed on their respective carriers 22 and 62, the interconnect regions 90, 100, 120 and 130 may be embedded into a suitable photoresist material and the spatial positions of waveguide facets and/or coupling structures detected. This may be achieved using an automated process involving machine vision. The path of the photonic wire can then be calculated such that it connects the respective receivers and transmitters in each transmitter/receiver pair, and the laser can be controlled and positioned so as to form the photonic wires. The unexposed (or at least ucured) photosensitive resist material is then removed and the photonic wires and the silicon substrate may be embedded in a suitable cladding material. The photonic wires may have diameters of only a few microns.

The photonic wires may form the sole interconnection between the semiconductor substrates, or they may provide connection regions to other waveguide structures that bridge the majority of the distance between the transmitter and the receiver pair.

If bi-directional data transmission is required, then a transmitter 120 and associated waveguide 122 is provided on the second semiconductor substrate 60, a further receiver 130 and associated waveguide 132 is provided on the first semiconductor substrate 20 and this receiver and transmitter pair are connected together by a second photonic wire 140.

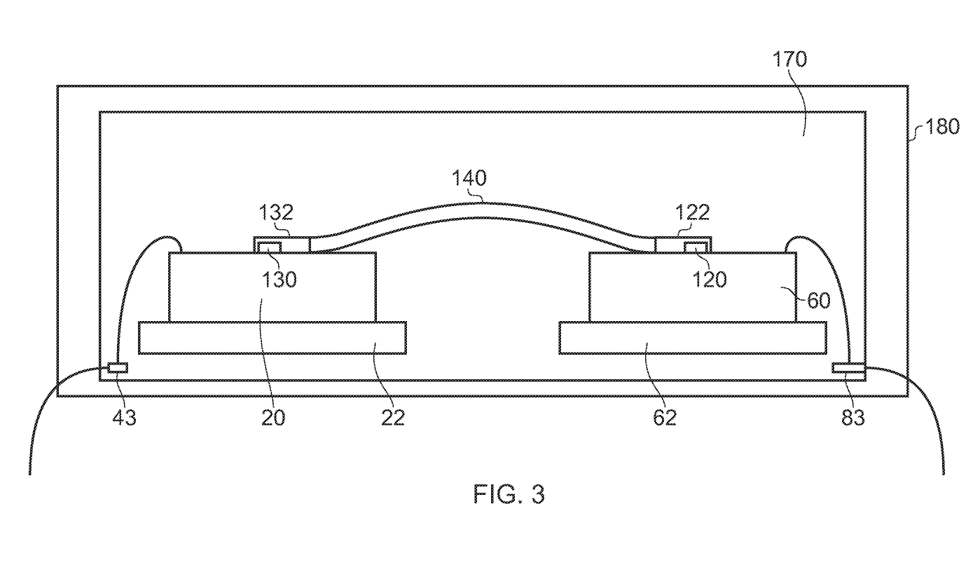

FIG. 3 shows the isolator of FIG. 2 in cross section along the line A-A′ and like parts have been designated with like reference numerals. The first and second semiconductor substrates 20 and 60, the first and second lead frames 22 and 62 and the photonic wires 140 are embedded within an insulating mold compound 170, whose composition is known to the person skilled in the art of integrated circuit packaging. The mold compound 170 forms a block of material containing the operational circuitry and the lead frames so as to protect it from environmental damage, for example ingress of moisture. The mold compound 170 and hence the circuits contained therein, is encapsulated within an integrated circuit package 180 such that the entire isolator is presented to an end user as single “chip”, despite the fact that in reality the package contains a plurality of galvanically isolated semiconductor substrates on respective lead frames. The mould compound may have a lower refractive index than the photonic wires so as to constrain light within the photonic wire.

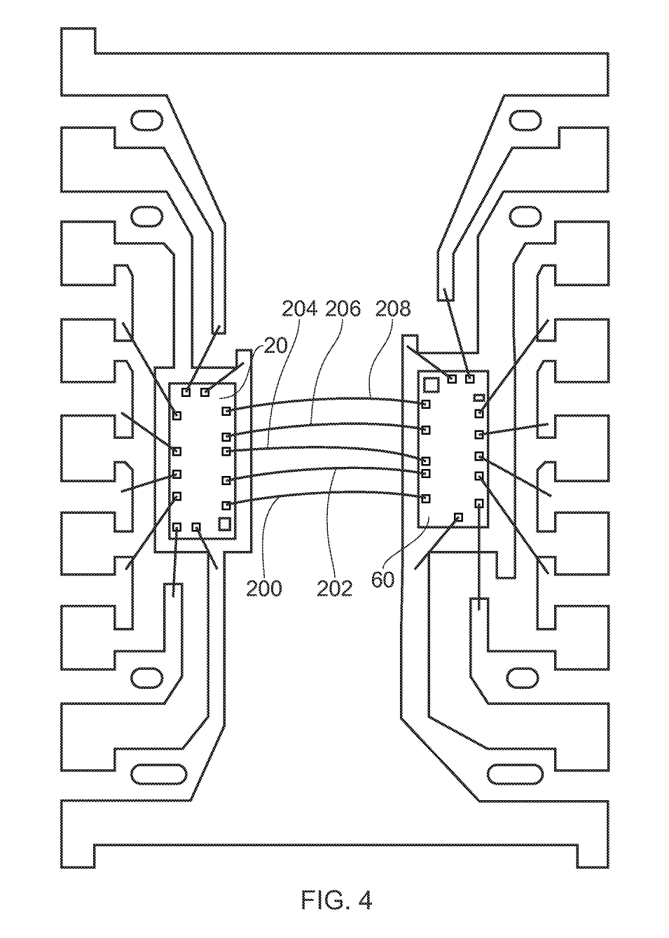

Although FIGS. 2 and 3 have been schematic representation, FIG. 4 is a more realistic plan view of an isolator where the first and second semiconductor substrates 20 and 60 are held on respective lead frames, and are interconnected by several photonic bond wires 200, 202, 204, 206 and 208.

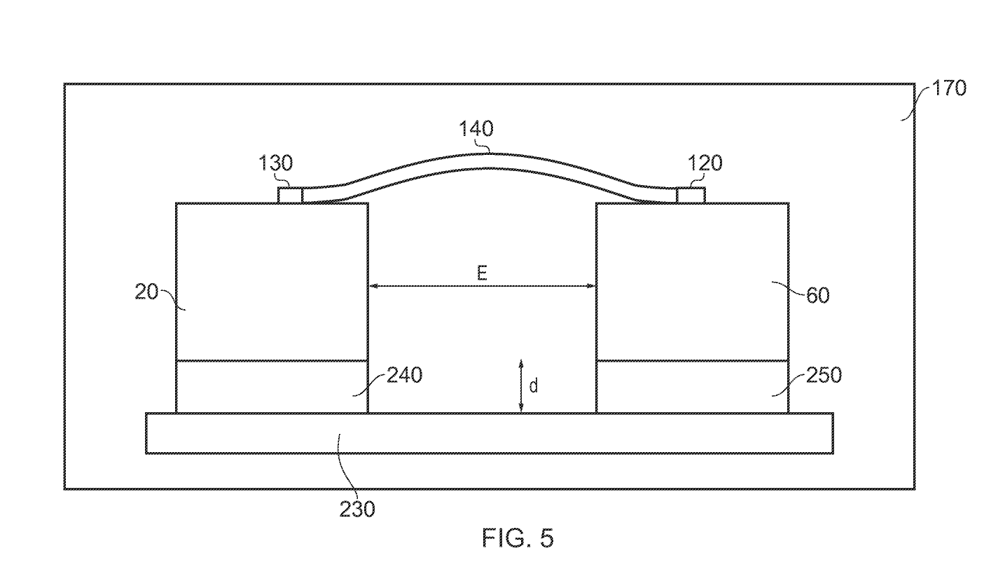

In a further embodiment, as shown in FIG. 5, the first semiconductor substrate 20 and the second semiconductor substrate 60 are interconnected by a plurality of photonic wires, of which 140 is shown as a single example. However the semiconductor substrates 20 and 60 are carried on a shared lead frame 230 but are attached to it, and isolated from it, by insulating bond regions 240 and 250 respectively. In the example shown in FIG. 5 the bond region 240 is the same height as the bond region 250 with the height represented by “d”. Thus an effective spacing of 2d is provided between the chips by the insulating bond material and a distance E exists between the two semiconductor substrates 20 and 60 by virtue of their physical separation within the mold material 170. These distances should be selected such that the resulting electric fields that extend across the bound regions 240, 250 and across the spacing E are less that generated by the breakdown voltage that the isolator is rated to withstand.

In a further variation, the doping of the semiconductor substrates may also be exploited to enhance isolation. Thus if a first region 20a of the first substrate 20 is doped with a first dopant to make it either N type or P type, then a second region 20b of the first substrate 20 may be doped with a second dopant on an opposite type, i.e. P type or N type respectively. Thus a P-N junction is formed at the boundary between regions 20a and 20b.

Similarly the second substrate 60 can be divided into regions 60a and 60b of different doping such that they also form a P-N junction.

If regions 60a and 20a are doped with the same dopant, then the electrostatic potential from region 20a, to 20b, across adhesive 240, through the lead frame 230, across the adhesive 250, and through region 60b to region 60a will cause one of the P-N junctions to be reverse based, giving a further increase in isolation between the regions 20a and 20b. However, if the relative potentials of the first and second dies can be known in advance, then it is possible to select the doping types such that both P-N junctions are reverse based.

It is thus possible to provide a chip package isolator exhibiting a high data transfer rate and good isolation. The isolator is not limited to only having two substrates therein, thus the circuit on the second substrate may act as an interface between the circuit on the first substrate and a logic circuit carried on a third substrate.

1. An isolator comprising:
a first semiconductor substrate including a first electrical circuit;
a second semiconductor substrate including a second electrical circuit;
and at least one optical waveguide for data exchange between the first and second electrical circuits.

2. An isolator as claimed in claim 1, in which the first and second semiconductor substrates are provided within a shared chip package.

3. An isolator as claimed in claim 2, in which the first substrate is mounted on a first lead frame and the second semiconductor substrate is mounted on a second lead frame.

4. An isolator as claimed in claim 3, in which the first and second lead frames, the first and second semiconductor substrates and the at least one optical waveguide are embedded within an insulating material.

5. An isolator as claimed in claim 1, in which a distance between the first semiconductor substrate and the second semiconductor substrate is greater than 100 microns

6. An isolator as claimed in claim 5, in which the distance between the first and second semiconductor substrates is greater than 200 microns.

7. An isolator as claimed in claim 5, in which the distance between the first and second semiconductor substrates is greater than 400 microns.

8. An isolator as claimed in claim 1, in which the first electrical circuit includes at least one optical transmitter and the second electrical circuit includes at least one optical receiver.

9. An isolator as claimed in claim 8, in which the second electrical circuit includes at least one optical transmitter and the first electrical circuit include at least one optical receiver.

10. An isolator as claimed in claim 8, in which the at least one optical transmitter comprises a nano-laser and a modulator.

11. An isolator as claimed in claim 8, in which the at least one optical receiver comprises a Schottky Detector.

12. An isolator as claimed in claim 1, in which the at last one optical waveguide comprises a photonic wire.

13. An isolator as claimed in claim 12, in which the photonic wire is formed of a plastic material.

14. An isolator as claimed in claim 1, further including a third semiconductor substrate.

15. An isolator as claimed in claim 1, in which the first and second semiconducting substrates are adhered to a shared lead-frame by an insulating material.

16. An isolator as claimed in claim 1, in which the photonic wire is formed in situ by photo-polymerization of a photopolymer material.

17. An isolator as claimed in claim 15 in which at least one of the semiconductor substrates is doped so as to have a reverse based P-N junction therein when it is subjected to a potential.

18. A method of providing electrical isolation within a single integrated circuit package having a first circuit formed using VLSI technology on a first semiconductor substrate and a second circuit formed using VLSI technology on a second semiconductor substrate, wherein the first and second semiconductor substrates are provided on respective carriers within the integrated circuit package, the method comprising exchanging data between the first and second circuits by way of optical signals conveyed by the photonic waveguides.

19. A method as claimed in claim 18, further comprising separating the first and second carriers from each other by at least 50 μm.

20. A method as claimed in claim 18, in which the photonic waveguides are formed by photonic wires.
